(19) United States
(12) Patent Application Publication
(10) Pub. No.: US 2023/0151722 A1
(43) Pub. Date: May 18, 2023

(54) FRACTURING APPARATUS AND STARTING METHOD THEREOF, FRACTURING APPARATUS SET

(71) Applicant: YANTAI JEREH PETROLEUM EQUIPMENT & TECHNOLOGIES CO., LTD., Yantai (CN)

(72) Inventors: Shuzhen CUI, Yantai (CN); Sheng CHANG, Yantai (CN); Shouzhe LI, Yantai (CN); Dawei ZHAO, Yantai (CN); Liang LV, Yantai (CN); Xincheng LI, Yantai (CN)

(73) Assignee: YANTAI JEREH PETROLEUM EQUIPMENT & TECHNOLOGIES CO., LTD., Yantai (CN)

(21) Appl. No.: 17/698,789

(22) Filed: Mar. 18, 2022

(30) Foreign Application Priority Data
Nov. 16, 2021 (CN) 202111355962.5

(51) Int. Cl. E21B 43/26; F04B 49/02; F04B 17/03

(52) U.S. Cl. CPC E21B 43/2607; F04B 49/02; F04B 17/03

(57) ABSTRACT

A fracturing apparatus, a starting method thereof and a fracturing apparatus set. The fracturing apparatus includes a fracturing pump, an electric motor and a start device; the fracturing pump is configured to pressurize low-pressure fluid into high-pressure fluid; the electric motor includes a first winding and a second winding; the start device includes a first switch and a second switch. Impedance of the first winding is greater than impedance of the second winding. One terminal of the first switch is connected with the first winding, the other terminal of the first switch is connected with the power supply device, one terminal of the second switch is connected with the second winding, and the other terminal of the second switch is connected with the power supply device.

### CROSS REFERENCES TO RELATED APPLICATIONS

The present application claims the priority of the Chinese patent application No. 202111355962.5 filed on Nov. 16, 2021, for all purposes, the disclosure of which is incorporated herein by reference in its entirety as part of the present application.

### TECHNICAL FIELD

At least one embodiment of the present disclosure relates to a fracturing apparatus, a starting method of a fracturing apparatus and a fracturing apparatus set.

### BACKGROUND

In the field of oil and natural gas exploitation, fracturing operation refers to a technology that uses high-pressure fracturing fluid to form cracks in oil and gas reservoirs during oil production or gas production. Through the fracturing operation, cracks can be formed in oil and gas reservoirs, which can improve the underground flow environment of oil or natural gas and increase the output of an oil well. Therefore, the fracturing reservoirs is the main stimulation method in oil and gas field exploitation. On the other hand, shale gas resources are abundant in the world, but due to a low permeability of shale formation, it has not been widely developed at present. As one of the core technologies of shale gas development, the fracturing technology can be widely used in shale reservoir reconstruction and shale gas exploitation.

Apparatuses used for the fracturing operation usually includes a sand mixing apparatus, a mixing apparatus, a fracturing apparatus and a fracturing fluid conveying apparatus. The sand mixing apparatus and the mixing apparatus can be used to prepare fracturing fluid with fracturing sands; the fracturing apparatus can pressurize the fracturing fluid to transform low-pressure fracturing fluid into high-pressure fracturing fluid; the fracturing fluid conveying apparatus can be used to convey the low-pressure fracturing fluid to the fracturing apparatus for pressurization, and can also be used to convey the pressurized high-pressure fracturing fluid to wellhead for the fracturing operation.

### SUMMARY

Embodiments of the present disclosure provides a fracturing apparatus, a starting method thereof and a fracturing apparatus set. The fracturing apparatus includes a fracturing pump, an electric motor and a start device; the fracturing pump is configured to pressurize low-pressure fluid into high-pressure fluid; the electric motor includes a first winding and a second winding; the start device includes a first switch and a second switch. Impedance of the first winding is greater than impedance of the second winding. One terminal of the first switch is connected with the first winding, the other terminal of the first switch is connected with the power supply device, one terminal of the second switch is connected with the second winding, and the other terminal of the second switch is connected with the power supply device.

At least one embodiment of the present disclosure provides a fracturing apparatus, which includes: a fracturing pump, configured to pressurize low-pressure fluid into high-pressure fluid; an electric motor, comprising a first winding and a second winding; and a start device, comprising a first switch and a second switch, impedance of the first winding is greater than impedance of the second winding, one terminal of the first switch is connected with the first winding, the other terminal of the first switch is connected with a power supply device, one terminal of the second switch is connected with the second winding, and the other terminal of the second switch is connected with the power supply device.

For example, in the fracturing apparatus provided by an embodiment of the present disclosure, the first winding comprises a three-phase winding, and the second winding comprises a three-phase winding.

For example, in the fracturing apparatus provided by an embodiment of the present disclosure, a ratio of the impedance of the first winding to the impedance of the second winding ranges from 2 to 5.

For example, in the fracturing apparatus provided by an embodiment of the present disclosure, the ratio of the impedance of the first winding to the impedance of the second winding ranges from 3 to 4.

For example, in the fracturing apparatus provided by an embodiment of the present disclosure, the start device further comprises a controller, which is respectively in communication connection with the first switch and the second switch, is configured to turn on the first switch at a first time and turn on the second switch at a second time after receiving a start signal of the electric motor, the second time is later than the first time.

For example, in the fracturing apparatus provided by an embodiment of the present disclosure, a time difference between the second time and the first time ranges from 5 seconds to 20 seconds.

For example, in the fracturing apparatus provided by an embodiment of the present disclosure, the power supply device comprises at least one selected from the group consisting of a power grid and an electric generator.

For example, the fracturing apparatus provided by an embodiment of the present disclosure further includes: a transmission mechanism, wherein one end of the transmission mechanism is connected with the fracturing pump, and the other end of the transmission mechanism is connected with the electric motor.

At least one embodiment of the present disclosure further provides a fracturing apparatus set, which includes at least one main fracturing apparatus, wherein the main fracturing apparatus is the abovementioned fracturing apparatus.

For example, in the fracturing apparatus set provided by an embodiment of the present disclosure, the fracturing apparatus set comprises a plurality of main fracturing apparatuses and a plurality of the start switches, wherein the plurality of start switches are arranged in one-to-one correspondence with the plurality of main fracturing apparatuses, and one terminal of each of the plurality of start switches is connected with a corresponding main fracturing apparatus, and the other terminal of the each of the plurality of start switches is connected with the power supply device.

For example, the fracturing apparatus set provided by an embodiment of the present disclosure further includes: an auxiliary fracturing apparatus in parallel with the at least one main fracturing apparatus; and a frequency converter, wherein one terminal of the frequency converter is connected with the power supply device, and the other terminal of the frequency converter is connected with the auxiliary fracturing apparatus.

For example, the fracturing apparatus set provided by an embodiment of the present disclosure further includes: a convert switch, wherein one terminal of the convert switch is connected with the main fracturing apparatus, and the other terminal of the convert switch is configured to be connected with the frequency converter or the power supply device.

At least one embodiment of the present disclosure further provides a starting method of a fracturing apparatus, wherein the fracturing apparatus includes the abovementioned fracturing apparatus, and the driving method comprises: turning on the first switch at a first time to connect the first winding with the power supply device; and turning on the second switch at a second time to connect the second winding with the power supply device, the second time is later than the first time.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of an electric drive fracturing apparatus;

FIG. 2 is a schematic diagram of another electric drive fracturing apparatus;

FIG. 3 is a schematic diagram of a fracturing apparatus provided by an embodiment of the present disclosure;

FIG. 4 is a starting method of a fracturing apparatus provided by an embodiment of the present disclosure;

FIG. 5 is a schematic diagram of a fracturing apparatus set provided by an embodiment of the present disclosure;

FIG. 6 is a schematic diagram of another fracturing apparatus set provided by an embodiment of the present disclosure; and

FIG. 7 is a schematic diagram of further another fracturing apparatus set provided by an embodiment of the disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly.

The fracturing apparatus includes a prime mover, a transmission mechanism and a fracturing pump, the prime mover is connected with the fracturing pump through the transmission mechanism to provide mechanical power to the fracturing pump through the transmission mechanism; the fracturing pump uses the mechanical power to pressurize low-pressure fluid into high-pressure fluid. Generally, a diesel engine is used as the prime mover in the fracturing apparatus, but the fracturing apparatus has the following disadvantages: (1) the diesel engine is large in size and weight, which easily leads to a large size and large weight of fracturing apparatus, resulting in limited transportation and low power density; (2) the diesel engine produces waste gas pollution and noise pollution during operation, which is not environmentally friendly; (3) the procurement cost of the diesel engine is relatively high, and the fuel consumption cost per unit power is high during operation.

Electric drive fracturing apparatus is a kind of fracturing apparatus using electric motor as power, and the electric drive fracturing apparatus usually includes an electric motor, a transmission mechanism and a fracturing pump; the motor is connected with the fracturing pump through the transmission mechanism to transmit mechanical power to the fracturing pump; the fracturing pump uses the mechanical power to convert the low-pressure fracturing fluid into the high-pressure fracturing fluid for fracturing operation. The electric drive fracturing apparatus adopts an electric motor to drive a plunger pump, so the electric drive fracturing apparatus has advantages of small size, economy, energy saving and environmental protection, etc. However, due to the inherent characteristics of the electric motor, upon the electric motor being directly started at full voltage, there is a short-term surge current which is usually several times of the rated current, such as 5 to 7 times. Because the power of the electric motor of the electric drive fracturing apparatus is large, such as more than 2000 KW, the current when the electric motor starts is large, which impacts the power supply device. If the power supply device is a power grid, it is easy to trip, and if the power supply device is an electric generator, it is easy to cause overload shutdown of the electric generator.

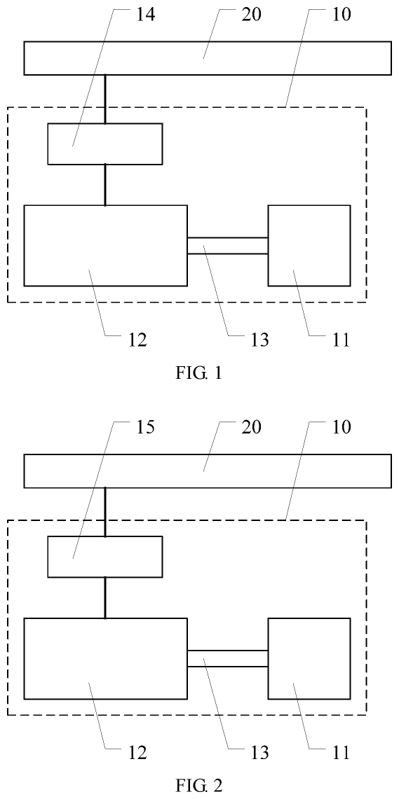

FIG. 1 is a schematic diagram of an electric drive fracturing apparatus. As shown in FIG. 1, the electric drive fracturing apparatus 10 includes a fracturing pump 11, an electric motor 12, a transmission mechanism 13 and a frequency converter 14. The electric motor 12 is connected to the fracturing pump 11 through the transmission mechanism 13, one terminal of the frequency converter 14 is connected to the power supply device 20, and the other terminal of the frequency converter 14 is connected to the electric motor 12. Therefore, the frequency converter can conveniently and flexibly adjust the rotation speed of the electric motor, thereby adjusting the displacement of the electric drive fracturing apparatus. On the other hand, because the electric motor is not directly connected with the power grid, the instantaneous current when the electric motor starts has no impact on the power supply device such as the power grid or the electric generator.

However, because the power supply voltage of the power grid is relatively high, and the composition of the frequency converter is relatively complex and includes many electronic components, the frequency converter is prone to breakdown and the reliability of the frequency converter is relatively low, which easily leads to the shutdown of the electric fracturing apparatus and the electric fracturing apparatus is not able to continuously operate. On the other hand, the frequency converter includes a high-voltage switch cabinet, a rectifier transformer, a rectifier unit, an inverter unit, a control unit, etc. Therefore, the cost of the frequency converter is relatively high, which leads to the relatively high cost of the electric fracturing apparatus.

FIG. 2 is a schematic diagram of another electric drive fracturing apparatus. As shown in FIG. 2, the electric fracturing apparatus 10 includes a fracturing pump 11, an electric motor 12, a transmission mechanism 13 and a soft start device 15; the electric motor 12 is connected to the fracturing pump 11 through the transmission mechanism 13, one terminal of the soft start device 15 is connected to the power supply device, and the other terminal of the soft start device 15 is connected to the electric motor 12. Therefore, the soft start device can reduce the start current of the electric generator.

However, the soft start device reduces the start current of the electric motor by reducing the start voltage of the electric motor, therefore the start torque of the motor is also greatly reduced, which is not suitable for the fracturing operation that is a high-load start operation. Moreover, the soft start device suitable for high voltage also includes complex electrical components, which has a low reliability and high cost.

In this regard, at least one embodiment of the disclosure provides a fracturing apparatus, a starting method thereof and a fracturing apparatus set. The fracturing apparatus includes a fracturing pump, an electric motor and a start device; the fracturing pump is configured to pressurize low-pressure fluid into high-pressure fluid; the electric motor includes a first winding and a second winding; the start device includes a first switch and a second switch. Impedance of the first winding is greater than impedance of the second winding. One terminal of the first switch is connected with the first winding, the other terminal of the first switch is connected with the power supply device, one terminal of the second switch is connected with the second winding, and the other terminal of the second switch is connected with the power supply device. The fracturing apparatus is configured to turn on the first switch when the electric motor starts, and utilize the first winding with the greater impedance to reduce the start current of the electric motor, and the fracturing apparatus is configured to turn on the second switch to electrically connect the second winding after the electric motor starts successfully, so as to run normally. Therefore, the fracturing apparatus can reduce the start current of the electric motor through the start device and the electric motor with the first winding and the second winding, and avoid the impact of the start current of the electric motor on the power supply device; moreover, the fracturing apparatus has high reliability and low cost. In addition, there is no need to reduce the start voltage of the fracturing apparatus, therefore the fracturing apparatus is suitable for high-load start applications, such as a fracturing operation.

Hereinafter, the fracturing apparatus, the starting method thereof and the fracturing apparatus set provided by the embodiments of the present disclosure are described in detail with reference to the attached drawings.

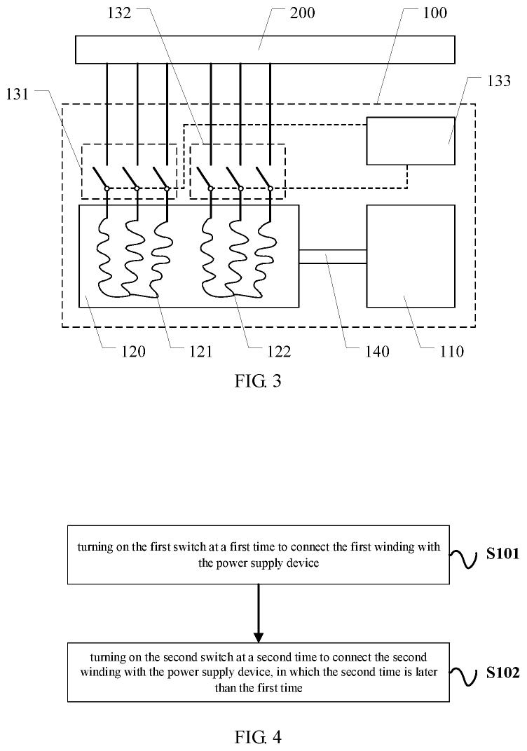

An embodiment of the present disclosure provides a fracturing apparatus. FIG. 3 is a schematic diagram of the fracturing apparatus provided by an embodiment of the present disclosure. As shown in FIG. 3, the fracturing apparatus 100 includes a fracturing pump 110, an electric motor 120 and a start device 130; the fracturing pump 110 is configured to pressurize low-pressure fluid (such as fracturing fluid) into a high-pressure fluid; the electric motor 120 includes a first winding 121 and a second winding 122; the start device 130 includes a first switch 131 and a second switch 132. The impedance of the first winding 121 is greater than impedance of the second winding 122. One terminal of the first switch 131 is connected to the first winding 121, the other terminal of the first switch 131 is connected to a power supply device 200, one terminal of the second switch 132 is connected to the second winding 122, and the other terminal of the second switch 132 is connected to the power supply device 200.

In the fracturing apparatus provided by the embodiment of the present disclosure, the electric motor has a plurality of windings, namely the first winding and the second winding, and the impedance of the first winding is greater than impedance of the second winding. When the electric motor starts, the first switch may be turned on to reduce the start current and complete the starting of the electric motor by using the first winding with the greater impedance; then, after the electric motor is successfully started, the second switch is turned on to electrically connect the second winding with the power supply device, so as to perform normal operation of the fracturing apparatus. Therefore, the fracturing apparatus has the following advantages: (1) the fracturing apparatus can reduce the start current of the electric motor through the start device and the electric motor with the first winding and the second winding, so as to avoid the impact of the start current of the electric motor on the power supply device; (2) because the fracturing apparatus does not need to be provided with an expensive transformer or soft start device, and the structure of the start device of the fracturing apparatus is simple, the fracturing apparatus has a higher reliability and lower cost; (3) there is no need to reduce the start voltage of the fracturing apparatus, therefore the fracturing apparatus is suitable for high-load start applications, such as a fracturing operation.

It should be noted that after the electric motor is started, the first switch may be kept on or turned off, and both of the two operations can realize the normal operation of the electric motor. In addition, the above-mentioned term “turn on the switch” means that the switch electrically connects the power supply device with the corresponding winding, and the switch is in a conducting state in this case; the above-mentioned term “turn off the switch” means that the switch disconnects the electrical connection between the power supply device and the corresponding winding, and the switch is in a non-conducting state in this case. On the other hand, because the electric motor runs at a fixed frequency after finishing starting, the displacement can be adjusted by replacing the fracturing pump.

In some examples, as shown in FIG. 3, the first winding 121 includes a three-phase winding, and the second winding 122 includes a three-phase winding. That is, the first winding and the second winding are not part of the existing three-phase windings in the electric motor, but two independent windings; both the first winding and the second winding operate independently.

In some examples, a ratio of the impedance of the first winding 121 to the impedance of the second winding 122 ranges from 2 to 5. Therefore, the fracturing apparatus can effectively reduce the start current of the electric motor and has lower cost.

In some examples, the ratio of the impedance of the first winding 121 to the impedance of the second winding 122 ranges from 3 to 4.

In some examples, as shown in FIG. 3, the start device 130 further includes a controller 133, the controller 133 is respectively in communication connection with the first switch 131 and the second switch 132, to control turning on and turning off of the first switch 131 and the second switch 132. The controller 133 is configured to turn on the first switch 131 at a first time and turn on the second switch 132 at a second time after receiving a start signal of the electric motor 120, and the second time is later than the first time. Therefore, the fracturing apparatus can turn on the first switch at the first time to reduce the start current and complete the starting of the electric motor by using the first winding with the greater impedance; then, the fracturing apparatus can turn on the second switch at the second time to electrically connect the second winding with the power supply device, so as to perform the normal operation.

In some examples, the modes of above-mentioned communication connection includes communication connection through wired connection (such as wires, optical fibers, etc.) and communication connection through wireless connection (such as WiFi, mobile network).

In some examples, the controller 133 described above may include a storage medium and a processor; the storage medium is configured to store a computer program; the processor is configured to execute compute programs in the storage medium to realize turning on the first switch at the first time to reduce the start current and finishing starting the electric motor by use the first winding with the greater impedance, and turning on the second switch at the second time to electrically connect the second winding with the power supply device, so as to perform normal operation.

For example, the storage medium mentioned above may be volatile memory and/or nonvolatile memory. The volatile memory may include, for example, random access memory (RAM) and/or cache. The nonvolatile memory may include, for example, a read-only memory (ROM), a hard disk, a flash memory, etc.

For example, the above-mentioned processor may be a central processing unit (CPU) or other types of processing devices with data processing capability and/or instruction execution capability, for example, it may include a microprocessor, a programmable logic controller (PLC), etc.

In some examples, a time difference between the second time and the first time ranges from 5 seconds to 20 seconds.

In some examples, as shown in FIG. 3, the power supply device 200 includes at least one selected from the group consisting of a power grid and an electric generator. That is, the power supply device may be a power grid; alternatively, the power supply device may be an electric generator or an electric generator set; alternatively, the power supply device may be a combination of an electric generator and a power grid.

In some examples, in the case where the power supply device includes a power grid, the power supply device may further include a voltage step-down substation, the voltage step-down substation is connected to the power grid to reduce the voltage.

In some examples, the rated frequency of the electric motor 120 is the same as the rated frequency of the power supply device 200, and the rated voltage of the electric motor 120 is substantially the same as the rated voltage of the power supply device 200. It should be noted that the above-mentioned term “substantially the same” refers to that the difference between the two is less than 10% of the average value of the two.

For example, the rated frequency of the electric motor 120 may be 50 Hz or 60 Hz; the rated voltage of the electric motor 120 may range from 6 kV-14 kV.

In some examples, as shown in FIG. 3, the fracturing apparatus 100 further includes a transmission mechanism 140, one end of the transmission mechanism 140 is connected with the fracturing pump 110, and the other end of the transmission mechanism 140 is connected with the electric motor 120. In this way, the transmission mechanism can transmit the mechanical power output by the electric motor to the fracturing pump.

In some examples, because the rotation speed of the electric motor is high, the fracturing apparatus can further include a speed reduction box, one terminal of the speed reduction box is connected with the transmission mechanism and the other terminal of the speed reduction box is connected with the plunger pump.

In some examples, the fracturing pump 110 may be a plunger pump, the plunger pump converts the mechanical power output by the electric motor into the reciprocating motion of the plunger of the plunger pump, and the reciprocating motion of the plunger can pressurize the low-pressure fluid into the high-pressure fluid at a hydraulic end of the plunger pump. For example, the plunger pump may include a crankshaft connection rod mechanism and the plunger, the crankshaft connection rod mechanism can convert a rotary motion into the reciprocating motion of the plunger, and at least a part of the plunger can extend into the hydraulic end to pressurize the low-pressure fluid in the hydraulic end. Of course, the embodiments of the present disclosure include but are not limited to this case, and other types of pumps may also be used as the fracturing pump.

The disclosed embodiment further provides a starting method of a fracturing apparatus. FIG. 4 is a starting method of a fracturing apparatus provided by an embodiment of the present disclosure. As shown in FIG. 4, the starting method includes the following steps:

S101: turning on the first switch at a first time to connect the first winding with the power supply device.

S102: turning on the second switch at a second time to connect the second winding with the power supply device, in which the second time is later than the first time.

In the starting method of the fracturing apparatus provided by at least one embodiment of the present disclosure, the electric motor has a plurality of windings, namely the first winding and the second winding, and the impedance of the first winding is greater than impedance of the second winding; in the starting method, the first switch is turned on at the first time to reduce the start current and finish starting the electric motor by using the first winding with the greater impedance; then, the starting method closes the second switch at the second time to connect the second winding with the power supply device, so as to perform normal operation. Therefore, the starting method of the fracturing apparatus has the following advantages: (1) the starting method of the fracturing apparatus can reduce the start current of the electric motor and avoid the impact of the start current of the electric motor on the power supply device; (2) because the starting method of the fracturing apparatus does not need to be provided with expensive transformer or soft start device, and the structure of the start device of the fracturing apparatus is simple, the starting method has a higher reliability and lower cost; (3) there is no need to reduce the start voltage of the fracturing apparatus, therefore the fracturing apparatus is suitable for high-load start applications, such as a fracturing operation.

In some examples, the starting method may further include: turning off the first switch at a third time to disconnect the first winding from the power supply device, and the third time is not earlier than the second time.

An embodiment of the present disclosure further provides a storage medium, a computer program is stored in the storage medium; upon the computer program being executed by the processor, the above-mentioned starting method of fracturing apparatus can be realized. Based on this understanding, the starting method of fracturing apparatus provided by the embodiment of the present disclosure can be embodied in the form of software products, the software products may be stored in a nonvolatile storage medium (which may be CD-ROM, U disk, removable hard disk, etc.); the non-volatile storage medium includes several instructions to make the electronic device including the processor execute the above-mentioned starting method of fracturing apparatus.

For example, an operation system and a network communication module may be further included in the storage medium. The operation system is a program that manages hardware and software, and supports the operation of information processing programs and other software and/or programs. The network communication module is configured to realize the communication between components in the storage medium and other hardware and software in an information processing entity device.

An embodiment of the present disclosure further provides an entity device, the entity device includes a storage medium and a processor; the storage medium is configured to store computer programs; and the processor is configured to execute the compute program in the storage medium to realize the starting method of the fracturing apparatus.

For example, the entity device mentioned above may be a single chip computer, a personal computer, a smart phone, a tablet computer, a smart watch, or other smart devices.

For example, the entity device mentioned above may further include a user interface, an input units, a network interface, a camera, a Radio Frequency (RF) circuit, a sensor, an audio circuit, a WI-FI module, etc. The user interface may include a display screen, and the input unit may include a keyboard, a mouse, etc.

For example, the storage medium mentioned above may be volatile memory and/or nonvolatile memory. The volatile memory may include, for example, random access memory (RAM) and/or cache. The nonvolatile memory may include, for example, a read-only memory (ROM), a hard disk, a flash memory, etc.

For example, the above-mentioned processor may be a central processing unit (CPU) or other types of processing devices with data processing capability and/or instruction execution capability, for example, it may include a microprocessor, a programmable logic controller (PLC) and the like.

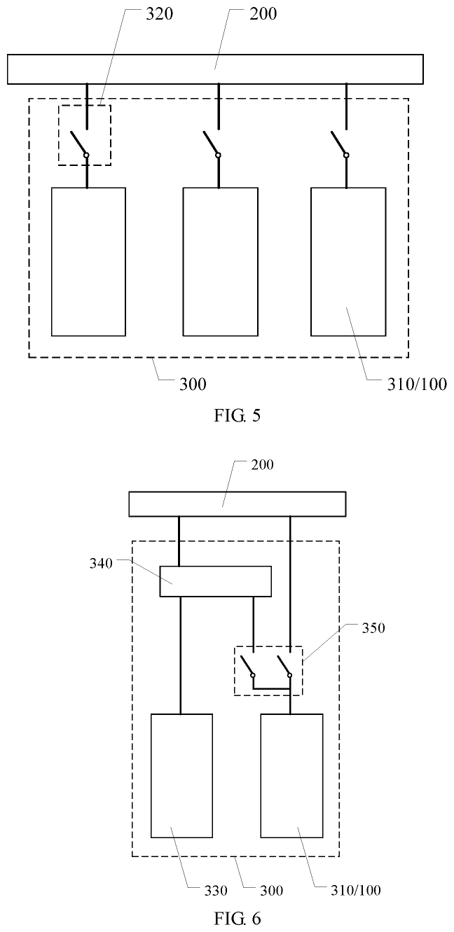

At least one embodiment of the present disclosure further provides a fracturing apparatus set. FIG. 5 is a schematic diagram of a fracturing apparatus set provided by an embodiment of the disclosure. As shown in FIG. 5, the fracturing apparatus set 300 includes at least one main fracturing apparatus 310, the main fracturing apparatus 310 may be the fracturing apparatus 100 provided in any one of the above examples. Therefore, the fracturing apparatus set 300 has beneficial effects corresponding to those of the fracturing apparatus 100. For example, the fracturing apparatus set can reduce the start current of the electric motor and avoid the impact of the start current of the electric motor on the power supply device; the fracturing apparatus set has a high reliability and low cost. The fracturing apparatus set is suitable for high-load start-up applications, such as a fracturing operation.

In some examples, as shown in FIG. 5, the fracturing apparatus set 300 includes a plurality of main fracturing apparatuses 310 and a plurality of start switches 320, the plurality of main fracturing apparatuses 310 are arranged in one-to-one correspondence with the main fracturing apparatus 310. One terminal of each start switch 320 is connected with the corresponding main fracturing apparatus 310, and the other terminal of the each start switch 320 is connected with the power supply device 200. Because the fracturing apparatus set may include a plurality of main fracturing apparatuses, the number of the main fracturing apparatus in operation can be changed by controlling the turning on and turning off of the start switch, so as to adjust the displacement of the fracturing fluid.

For example, as shown in FIG. 5, the fracturing apparatus set 300 includes three main fracturing apparatuses 310 and three start switches 320, and each main fracturing apparatus 310 is connected to the power supply device 200 through one start switch 320. Of course, the embodiments of the present disclosure include but are not limited to this case. The number of the main fracturing apparatus in the fracturing apparatus set may be determined according to the actual required displacement and the displacement of a single main fracturing apparatus.

FIG. 6 is a schematic diagram of another fracturing apparatus set provided by an embodiment of the disclosure. As shown in FIG. 6, the fracturing apparatus set 300 further includes an auxiliary fracturing apparatus 330 and a frequency converter 340; the auxiliary fracturing apparatus 330 is arranged in parallel with at least one main fracturing apparatus 310; one terminal of the frequency converter 340 is connected to the power supply device 200, and the other terminal of the frequency converter 340 is connected to the auxiliary fracturing apparatus 330. As mentioned above, the fracturing apparatus adopted by the main fracturing apparatus keeps operating with a constant frequency after finishing the start-up, which has the advantages of a high reliability and low cost. And the auxiliary fracturing apparatus is connected with the frequency converter, so the speed or power of the electric motor in the auxiliary fracturing apparatus can be adjusted by the frequency converter. Therefore, through the combination of main fracturing apparatus, the auxiliary fracturing apparatus and the frequency converter, the fracturing apparatus set can not only improve the reliability and reduce cost, but also flexibly adjust the displacement through the auxiliary fracturing apparatus.

It should be noted that the auxiliary fracturing apparatus also includes a fracturing pump, an electric motor and a transmission mechanism, but the electric motor of the auxiliary fracturing apparatus does not include a plurality of windings. For example, the electric motor of the auxiliary fracturing apparatus only includes a winding for normal operation of the electric motor.

In some examples, the displacement of the main fracturing apparatus is greater than displacement of the auxiliary fracturing apparatus, so that the number or the specification of the auxiliary fracturing apparatus in the fracturing apparatus set can be reduced, thereby reducing the total cost of the fracturing apparatus set.

In some examples, as shown in FIG. 6, the fracturing apparatus set 300 further includes a convert switch 350, one terminal of the convert switch is connected with the main fracturing apparatus 310, and the other terminal of the convert switch 350 is configured to be connected with the frequency converter 340 or the power supply device 200. That is, the changeover switch 350 can enable the main fracturing apparatus 310 to be selectively connected to the frequency converter 340 or to the power supply device 200. Therefore, the main fracturing apparatus 310 can also utilize the frequency converter 340 to adjust the displacement.

For example, as shown in FIG. 6, in the case where the electric motor of the main fracturing apparatus 310 is started, the convert switch 350 can be converted to be connected with the power supply device 200 without impacting the power supply device 200; in the case where the electric motor of the auxiliary fracturing apparatus 330 is started, it can be started by the frequency converter 340, so it cannot impact the power supply device 200. Upon the fracturing apparatus set 300 running normally and the total displacement needs to be adjusted, on the one hand, the displacement of the auxiliary fracturing apparatus set 330 can be directly adjusted by the frequency converter 340 to achieve the purpose of adjusting the total displacement of the fracturing apparatus set 300, on the other hand, the convert switch 350 can be converted to be connected with the frequency converter 340, so as to adjust the displacement of the main fracturing apparatus set 310 by the frequency converter 340 and achieve the purpose of adjusting the total displacement of the fracturing apparatus set 300.

For example, as shown in FIG. 6, the fracturing apparatus set 300 includes one main fracturing apparatus 310, one auxiliary fracturing apparatus 330, one frequency converter 340 and one convert switch 350; the main fracturing apparatus 310 is connected with the convert switch 350, and the auxiliary fracturing apparatus 330 is connected with the frequency converter 340. It should be noted that the number of the main fracturing apparatus and auxiliary fracturing apparatus in this fracturing apparatus set includes but is not limited to the above cases, and may be determined according to actual needs.

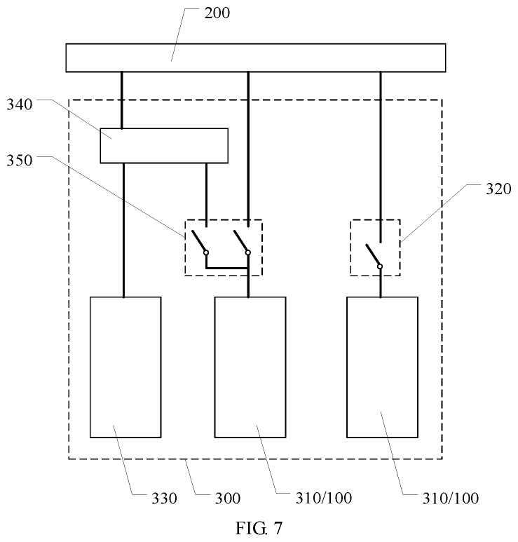

FIG. 7 is a schematic diagram of another fracturing apparatus set provided by an embodiment of the disclosure. As shown in FIG. 7, the fracturing apparatus set 300 includes a main fracturing apparatus 310 connected with the start switch 320 and a main fracturing apparatus 310 connected with the convert switch 350. Therefore, the fracturing apparatus set can flexibly set the connection mode of the main fracturing apparatus, so as to maximize the benefits of displacement and cost.

The following statements should be noted:

(1) The accompanying drawings involve only the structure(s) in connection with the embodiment(s) of the present disclosure, and other structure(s) can be referred to common design(s).

(2) In case of no conflict, the embodiments of the present disclosure and the features in the embodiments can be combined with each other to obtain new embodiments.

What have been described above are only specific implementations of the present disclosure, the protection scope of the present disclosure is not limited thereto, and easily conceivable changes or substitutions should be covered within the protection scope of the present disclosure. Therefore, the protection scope of the present disclosure should be based on the protection scope of the claims.

What is claimed is:

1. A fracturing apparatus, comprising:
a fracturing pump, configured to pressurize low-pressure fluid into high-pressure fluid;
an electric motor, comprising a first winding and a second winding; and
a start device, comprising a first switch and a second switch,
wherein impedance of the first winding is greater than impedance of the second winding, one terminal of the first switch is connected with the first winding, the other terminal of the first switch is connected with a power supply device, one terminal of the second switch is connected with the second winding, and the other terminal of the second switch is connected with the power supply device.

2. The fracturing apparatus according to claim 1, wherein the first winding comprises a three-phase winding, and the second winding comprises a three-phase winding.

3. The fracturing apparatus according to claim 1, wherein a ratio of the impedance of the first winding to the impedance of the second winding ranges from 2 to 5.

4. The fracturing apparatus according to claim 3, wherein the ratio of the impedance of the first winding to the impedance of the second winding ranges from 3 to 4.

5. The fracturing apparatus according to claim 1, wherein the start device further comprises a controller, which is respectively in communication connection with the first switch and the second switch, is configured to turn on the first switch at a first time and turn on the second switch at a second time after receiving a start signal of the electric motor, the second time is later than the first time.

6. The fracturing apparatus according to claim 5, wherein a time difference between the second time and the first time ranges from 5 seconds to 20 seconds.

7. The fracturing apparatus according to claim 1, wherein the power supply device comprises at least one selected from the group consisting of a power grid and an electric generator.

8. The fracturing apparatus according to claim 1, further comprising:
a transmission mechanism, wherein one end of the transmission mechanism is connected with the fracturing pump, and the other end of the transmission mechanism is connected with the electric motor.

9. A fracturing apparatus set, comprising at least one main fracturing apparatus, wherein the main fracturing apparatus is the fracturing apparatus according to claim 1.

10. The fracturing apparatus set according to claim 9, wherein the fracturing apparatus set comprises a plurality of main fracturing apparatuses and a plurality of the start switches, wherein the plurality of start switches are arranged in one-to-one correspondence with the plurality of main fracturing apparatuses, and one terminal of each of the plurality of start switches is connected with a corresponding main fracturing apparatus, and the other terminal of the each of the plurality of start switches is connected with the power supply device.

11. The fracturing apparatus set according to claim 9, further comprising:
an auxiliary fracturing apparatus in parallel with the at least one main fracturing apparatus; and
a frequency converter, wherein one terminal of the frequency converter is connected with the power supply device, and the other terminal of the frequency converter is connected with the auxiliary fracturing apparatus.

12. The fracturing apparatus set according to claim 11, further comprising:
a convert switch, wherein one terminal of the convert switch is connected with the main fracturing apparatus, and the other terminal of the convert switch is configured to be connected with the frequency converter or the power supply device.

13. A starting method of a fracturing apparatus, wherein the fracturing apparatus comprises the fracturing apparatus according to claim 1, and the driving method comprises:
turning on the first switch at a first time to connect the first winding with the power supply device; and
turning on the second switch at a second time to connect the second winding with the power supply device, the second time is later than the first time.
